(19) United States
(12) Patent Application Publication
(10) Pub. No.: US 2012/0260482 A1
(43) Pub. Date: Oct. 18, 2012

(54) METHOD AND APPARATUS FOR ASSEMBLING A CLUTCH

(75) Inventor: John Graham, Clinton Township, MI (US)

(73) Assignee: COMAU INC., Southfield, MI (US)

(21) Appl. No.: 13/180,891

(22) Filed: Jul. 12, 2011

Related U.S. Application Data
(60) Provisional application No. 61/363,510, filed on Jul. 12, 2010.

(51) Int. Cl. B23P 21/00; B23P 11/00

(52) U.S. Cl. 29/407.01; 29/428; 29/525.01; 29/822; 29/705; 901/41

(57) ABSTRACT

A method and apparatus for automatically assembling a clutch of an automatic transmission of a motor vehicle. The method and apparatus includes providing an assembly station having an assembly table with a clutch fixture connected to the assembly table and adaptable to receive a clutch housing. At least one tray is connected to the assembly table and is adaptable to receive clutch components of the clutch. At least one robotic arm is engageable with the clutch housing and the clutch components for loading and unloading the clutch housing onto and from the clutch fixture and the clutch components from at least one tray. A manipulator connected to and in communication with the at least one robotic arm automatically engages an appropriate tool for assembling the clutch components into the clutch housing. At least one assembly fixture is removably connected to the clutch fixture and connectable to the clutch housing for assisting in the assembly of the clutch components to the clutch housing.

### CROSS-REFERENCE TO RELATED APPLICATIONS

This application claims the benefit of U.S. Provisional Patent Application Ser. No. 61/363,510, which was filed on Jul. 12, 2010.

### FIELD OF THE INVENTION

The present invention relates to the field of methods and apparatuses for assembling complex products and, in particular, a method and apparatus for assembling and testing a motor vehicle automatic transmission clutch in a parallel process system.

### BACKGROUND OF THE INVENTION

In today's manufacturing industry, the customary manner of assembling products is with an assembly line in a serial process system. A serial process system is defined as having the complex product travel through successive, single operations or stations in order to complete the assembly of the complex product. Serial process systems are even more common when such products are complex in nature, thereby requiring the assembly of a variety of different subcomponents and various individual components in various locations on the product.

Typically, the serial process of an assembly line begins with the delivery of a complex product to the assembly line wherein the complex product is then loaded into an assembly line transport system, either automatically or manually. The transport system carries the complex product to a variety of workstations along the assembly line, wherein the various components and subcomponents are assembled into the complex product. For example, in a serial processed engine cylinder head assembly line, spark plugs may be installed into the cylinder head at the first workstation, and after the spark plugs are installed, the transport system may carry the cylinder head to a second workstation, wherein the cylinder head may be rotated so that additional componentry may be assembled on the underside or opposite side of the cylinder head. Cylinder head valves may be installed into the cylinder head at a subsequent workstation, and upon traveling to the next workstation, the cylinder head may be rotated back to its original position. The following workstation may then be responsible for installing valve springs into the cylinder head. The transport system continues to carry the cylinder head from workstation to workstation until the cylinder head is completely assembled. The number of workstations on the assembly line may vary, depending on the type of cylinder head or componentry. Typically, the number of workstations range in the neighborhood of six to eight with the transport system passing through or adjacent to each of the workstations.

The timing of the workstations and the transport system is critical for such assembly lines. In the above-noted example, the complex product moves from one workstation to the next, wherein the transport system may stop to allow for an operation to be performed at each of the workstations. A certain amount of time may even be designated for completing a specific task at a specific workstation.

Although assembly lines have been utilized throughout the history of the manufacturing industry, such assembly lines are plagued with inefficiencies. For instance, assembly lines within the automotive industry are typically dedicated to a particular component of an automobile and for a specific model of an automobile. Thus, such assembly lines cannot be utilized to manufacture any component of an automobile, but rather, they can be only utilized to build certain specific components. Therefore, if the particular component is no longer needed, for instance, the particular model of automobile in which the component is utilized is no longer being manufactured, and then the particular assembly line cannot be utilized without major retooling. Therefore, the assembly line must be retooled or disassembled, and a new assembly line must be installed. This is, of course, a very timely and costly task, and one that is undesirable in an industrial environment.

As previously mentioned, such assembly lines are typically timed to provide each laborer at a particular workstation a specific amount of time under which to complete the operation at that particular workstation. If a problem occurs at that particular workstation such that the task can no longer be performed, for instance, a tool breaks, the transport system shuts down, certain components are defective, etc., then the entire assembly line may have to be shut down until the problem is corrected. When this occurs, manufacturing of the particular product is halted, thereby causing a shortage of the product being manufactured or assembled on that particular assembly line. Such a shortage of products could create shortages in other assembly lines thereby requiring other assembly lines to shut down. Thus, manufacturing facilities often produce a surplus of components so that a sufficient supply of components is provided should the assembly line break down or stop. Such uncertainty in the operation of the assembly line may lead to a shortage or a surplus of components. A shortage of components may lead to other assembly lines being short of parts, and a surplus of components may mean that unnecessary parts have been produced, thereby wasting time and money. Either situation creates an inefficiency that is undesirable in an industrial environment.

Lastly, assembly lines often span across a rather large area of the manufacturing facility in order to provide a sufficient amount of space for the transport system, the work stations, and the laborers. The floor space in a manufacturing facility can be rather expensive, and therefore, it is always desirable to reduce the amount of floor space to produce a particular product.

It would be desirable to provide a method and apparatus for assembling a clutch in a parallel process system that would require a minimum amount of factory floor space.

### SUMMARY OF THE INVENTION

The present invention relates to a method and apparatus for automatically assembling a clutch of an automatic transmission of a motor vehicle. The apparatus of the present invention provides an assembly station having an assembly table, wherein a clutch fixture is connected to the assembly table and is adaptable to receive a clutch housing. At least one tray is connected to the assembly table and is adaptable to receive clutch components of the clutch. At least one robotic arm is engageable with the clutch housing and the clutch components for loading and unloading the clutch housing onto and from the clutch fixture and the clutch components into and from the at least one tray. A manipulator is connected to and in communication with the at least one robotic arm for automatically engaging an appropriate tool for assembling the clutch components into the clutch housing. At least one assembly fixture is removably connected to the clutch fixture and connectable to the clutch housing for assisting in the assembly of the clutch components to the clutch housing.

The assembly fixture of the apparatus may provide an outer and inner seal sleeve removably connected to the clutch fixture and engageable with the clutch housing for assisting in the assembly of the clutch components of the clutch housing. The assembly fixture of the apparatus may also provide a snap ring mounting device releasably connected to the clutch fixture and engageable with the clutch housing for assisting in the assembly of the clutch components to the clutch housing. The assembly fixture of the apparatus may also provide a plate having a stepped cylindrical structure connected thereto and engageable with the clutch housing. A pair of substantially cylindrical posts may be connected to the plate adjacent the stepped cylindrical structure for receiving the at least one assembly fixture.

The tool engaged by the manipulator of the apparatus may include a vacuum gripper releasably engageable with the clutch components for moving and assembling the clutch components into the clutch housing. The tool of the apparatus may also provide a rotatable press engageable with the clutch components for assembling the clutch components to the clutch housing. In addition, the tool of the apparatus may include at least one spring-loaded plunger engageable with the clutch components for maintaining the clutch components in a predetermined position while assembling the clutch components to the clutch housing. The tool may also provide a snap ring press engageable with the clutch components for assembling the clutch components to the clutch housing.

The apparatus of the present invention may also include a test station engageable with an assembled clutch housing for testing the structural and functional integrity of the assembled clutch housing.

The method of the present invention may include the steps of providing an assembly station having an assembly table, a clutch fixture connected to the assembly table, at least one tray connected to the assembly table, and at least one robotic arm. The steps may further include placing a clutch housing on the clutch fixture and the clutch components in at least one tray with the at least one robotic arm. The method may further include engaging an appropriate tool with the manipulator connected to and in communication with the at least one robotic arm for assembling the clutch components to the clutch housing and removably connecting at least one assembly fixture to the clutch fixture and the clutch housing to assist in the assembly of the clutch components to the clutch housing.

The method of the present invention may also include providing an inner and outer sleeve as the at least one assembly fixture. In addition, the steps may include providing a snap ring mounting device as the at least one assembly fixture. The method may include providing a plate as the plate clutch fixture having a stepped cylindrical structure connected thereto for receiving and securing a clutch housing, wherein a pair of substantially cylindrical posts may be connected to the plate adjacent the stepped cylindrical structure for receiving the at least one assembly fixture.

The method of the present invention may also include providing a vacuum gripper as the tool for releasably engaging the clutch components and moving the clutch components into the clutch housing. The steps may also include providing a rotatable press as the tool for engaging the clutch components and applying pressure to the clutch components and the clutch housing. The method may also include providing at least one spring-loaded plunger as the tool for engaging and maintaining the clutch components in a predetermined position in the clutch housing. The steps may also include providing a snap ring press as the tool for engaging the clutch components and assembling the clutch components to the clutch housing.

Lastly, the method of the present invention may include providing a test station engageable with an assembled clutch housing for testing the structural and functional integrity of the assembled clutch housing.

### BRIEF DESCRIPTION OF THE DRAWINGS

The description herein makes reference to the accompanying drawings wherein like reference numerals refer to like parts throughout the several views, and wherein:

FIG. 1 is a cross-section view showing a fully-assembled clutch of a motor vehicle automatic transmission;

FIG. 2 is a perspective view showing a clutch assembly cell of the method and apparatus of the present invention;

FIG. 3 is a perspective view showing an assembly area of the clutch assembly cell of the method and apparatus of the present invention;

FIG. 4 is a perspective view showing the assembly area, wherein a seal assembly sleeve is installed with respect to a clutch housing of the method and apparatus of the present invention;

FIG. 5A shows a first kit position of a kit tray of the method and apparatus of the present invention;

FIG. 5B shows a second kit position of the method and apparatus of the present invention;

FIG. 5C shows a third kit position of the method and apparatus of the present invention;

FIG. 6 is an illustration showing loading of the clutch housing with respect to a fixture of the method and apparatus of the present invention;

FIG. 7 is an illustration showing loading of an outer sleeve seal and an inner sleeve seal with respect to the clutch housing of the method and apparatus of the present invention;

FIG. 8 is an illustration showing loading of an outer seal with respect to the clutch housing of the method and apparatus of the present invention;

FIG. 9 is an illustration showing transfer of a partially-assembled clutch to a press-and-rotate tool of the method and apparatus of the present invention;

FIG. 10 is an illustration showing the press-and-rotate tool of the method and apparatus of the present invention;

FIG. 11 is an illustration showing loading of a disc spring with respect to the clutch housing of the method and apparatus of the present invention;

FIG. 12 is an illustration showing loading of an inner piston sleeve with respect to the clutch housing of the method and apparatus of the present invention;

FIG. 13 is an illustration showing registration of a tool with a tab in a seal plate of the method and apparatus of the present invention;

FIG. 14 is an illustration showing loading of an inner seal of the method and apparatus of the present invention;

FIG. 15 is an illustration showing the partially-assembled clutch, wherein assembly of the seals is completed of the method and apparatus of the present invention;

FIG. 16 is an illustration showing loading of a snap ring cone with respect to the clutch housing of the method and apparatus of the present invention;

FIG. 17 is an illustration showing installation of an inner snap ring with respect to the housing of the method and apparatus of the present invention;

FIG. 18 is an illustration showing the partially-assembled clutch subsequent to installation of the inner snap ring of the method and apparatus of the present invention;

FIG. 19 is an illustration showing loading of a clutch pack with respect to the clutch housing of the method and apparatus of the present invention;

FIG. 20 is an illustration showing loading of an outer snap ring with respect to the clutch housing a snap ring sleeve of the method and apparatus of the present invention;

FIG. 21 is an illustration showing a pressing operation, whereby the outer snap ring is pressed into position of the method and apparatus of the present invention; and

FIG. 22 is a process flow diagram showing the assembly steps for assembling the clutch of the method and apparatus of the present invention.

### DETAILED DESCRIPTION OF EMBODIMENTS OF THE INVENTION

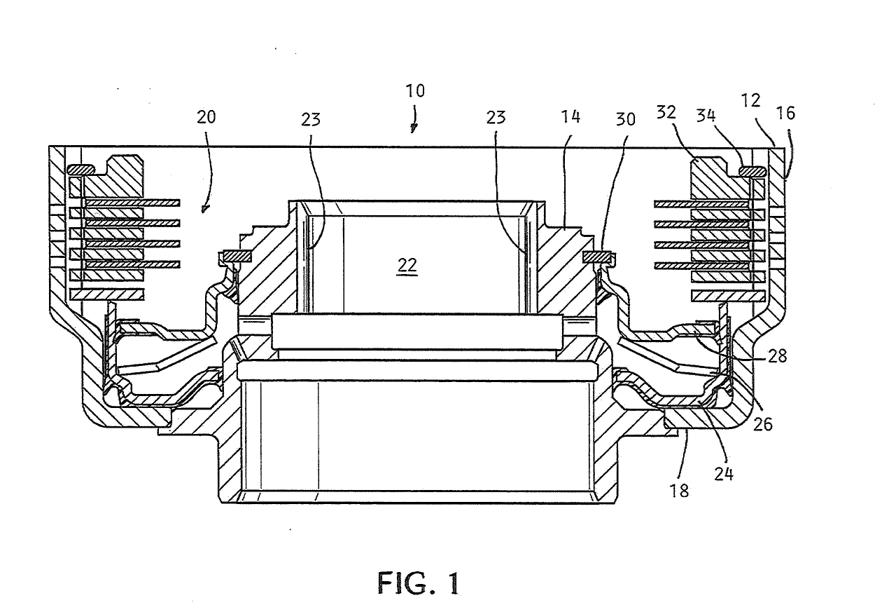

FIG. 1 shows a clutch 10 in a fully-assembled condition. The clutch 10 is conventional in design and is a component of an automatic transmission (not shown) of a motor vehicle (not shown).

The clutch 10 includes a substantially cylindrical clutch housing 12. The clutch housing 12 defines an inner radial wall 14, an outer radial wall 16, and a base wall 18. The inner radial wall 14, the outer radial wall 16, and the base wall 18 cooperate to define an internal annular channel 20 of the clutch housing 12. The internal annular channel 20 extends around a central bore 22 of the clutch housing 12, which is defined by the inner radial wall 14 of the clutch housing 12. The central bore 22 has splined gear teeth 23 extending along a longitudinal axis of said central bore 22.

Various components of the clutch 10 are arranged within the internal annular channel 20 of the clutch housing 12. In particular, an outer substantially circular seal 24 is located adjacent to the base wall 18, a substantially circular disc spring 26 is located adjacent to the outer seal 24 opposite the base wall 18, an inner substantially circular seal 28 is disposed adjacent to the disc spring 26 and is secured in place by an inner substantially circular snap ring 30, a substantially circular clutch pack 32 is disposed adjacent to the outer radial wall 16 outward from the outer seal 24, the disc spring 26, and the inner seal 28, and an outer substantially circular snap ring 34 secures the clutch pack 32 in place with respect to the clutch housing 12. Those skilled in the art would be familiar with the conventional design of the clutch 10 of an automatic transmission of a motor vehicle.

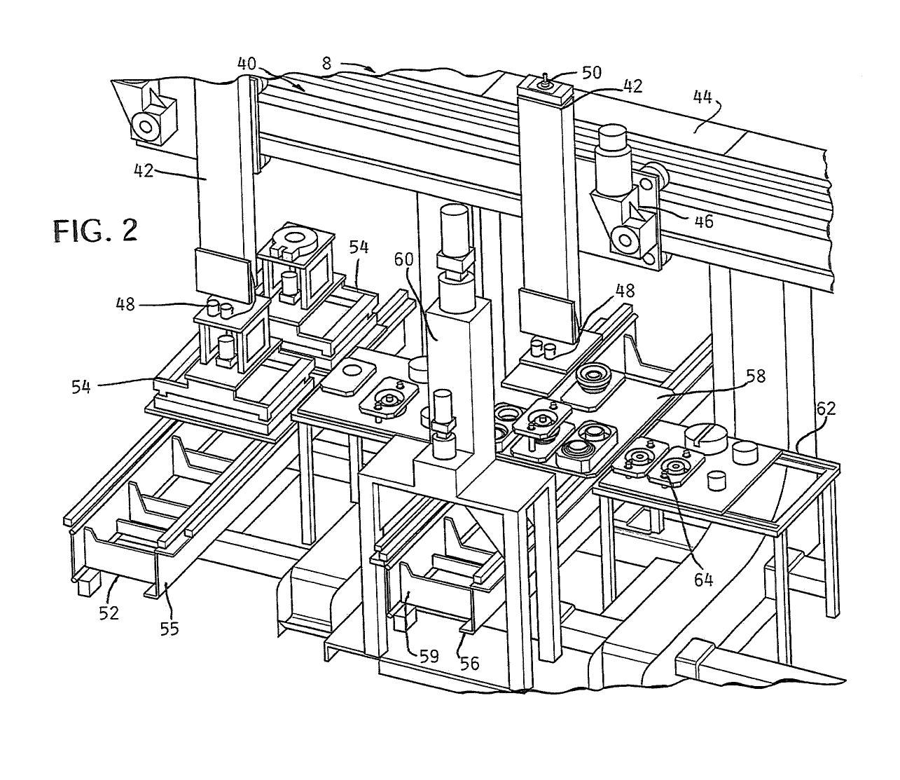

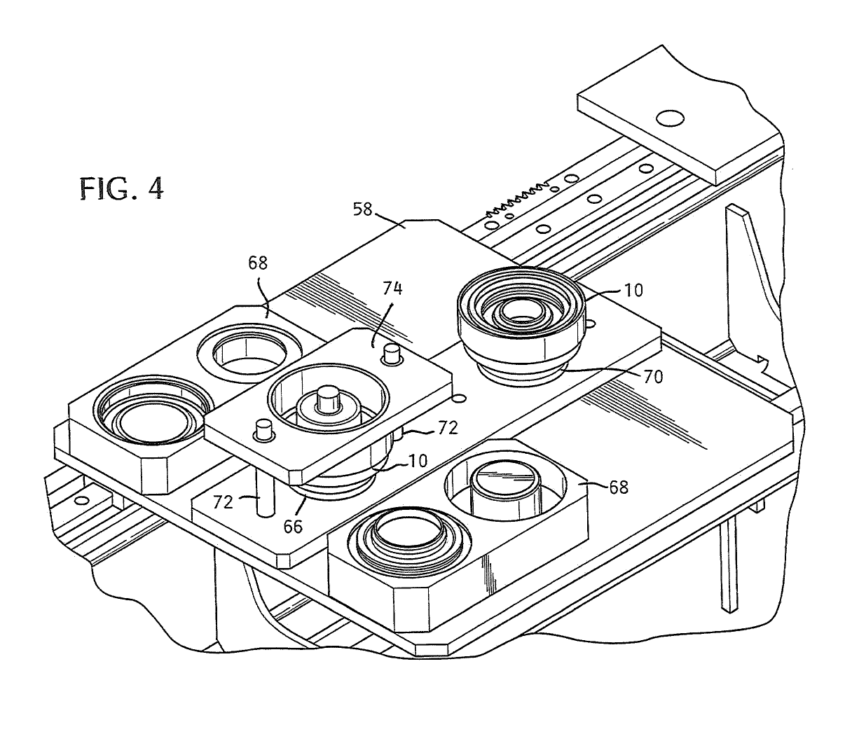

FIGS. 2-21 illustrate a method and apparatus 8 for assembling the clutch 10 of a motor vehicle automatic transmission. As shown in FIG. 2, the clutch 10 is assembled within a clutch assembly cell 40. The clutch assembly cell 40 includes one or more robotic arms 42. The robotic arms 42 may be supported on an overhead gantry 44 for movement along an X-axis and may be driven along the X-axis by a drive mechanism 46 that is associated with each of the robotic arms 42. However, it should be noted that other forms of moving the robotic aims 42 may be utilized besides the overhead gantry 44.

Each robotic arm 42 further includes a manipulator 48 that is connectable to various types of tools 64 for performing assembly processes, as will be described herein. The manipulator 48 is moveable along a Z-axis, or elevation axis, using a linear actuator 50 or other suitable structure. While the clutch assembly cell 40 need only include a single robotic arm 42 in order to perform the method described herein, it is specifically contemplated that multiple robotic arms 42 may be provided, thus allowing certain steps of the method to be performed simultaneously, that is, in parallel with one another. In addition, the robotic arm 42 may be self-standing on a rotatable base (not shown) as opposed to the overhead gantry 44.

The clutch assembly cell 40 includes a test station 52 on which testing fixtures 54 are slidably mounted on a pair of substantially parallel rails 55 for movement in a Y-direction. In particular, multiple testing fixtures 54 may be provided on the test station 52 for movement into and out of registration with the robotic arms 42 in the Y-direction, thus allowing testing to be performed on the assembled clutch 10 that is disposed on the test station 52 that is not in registration with the robotic arms 42 while another clutch 10 is being loaded or unloaded with respect to another test station 52 that is in registration with the robotic arms 42 in the Y-direction.

The clutch assembly cell 40 also includes an assembly station 56 on which an assembly table 58 is slidably mounted on a pair of substantially parallel rails 59 for movement into and out of registration with respect to the robotic arms 42. In particular, the assembly table 58 is able to move between at least a first position, wherein the assembly table 58 is disposed in registration with the robotic arms 42 such that the clutch 10 may be loaded, unloaded, or assembled on the assembly table 58, and a second position, wherein the assembly table 58 places the clutch 10 in registration with a press-and-rotate tool 60.

The clutch assembly cell 40 also includes one or more tool tables 62 upon which tools 64 are supported for use by the robotic arms 42. In particular, the tools 64 may be selectively attached to and detached from the manipulator 48 of each robotic arm 42 for performing various assembly operations. Thus, during the assembly process, the robotic arm 42 may use multiple tools 64 by selectively detaching a first tool 64 from the manipulator 48 and placing it on the tool table 62, and subsequently attaching the manipulator 48 of the robotic arm 42 to a second tool 64 that is disposed on the tool table 62.

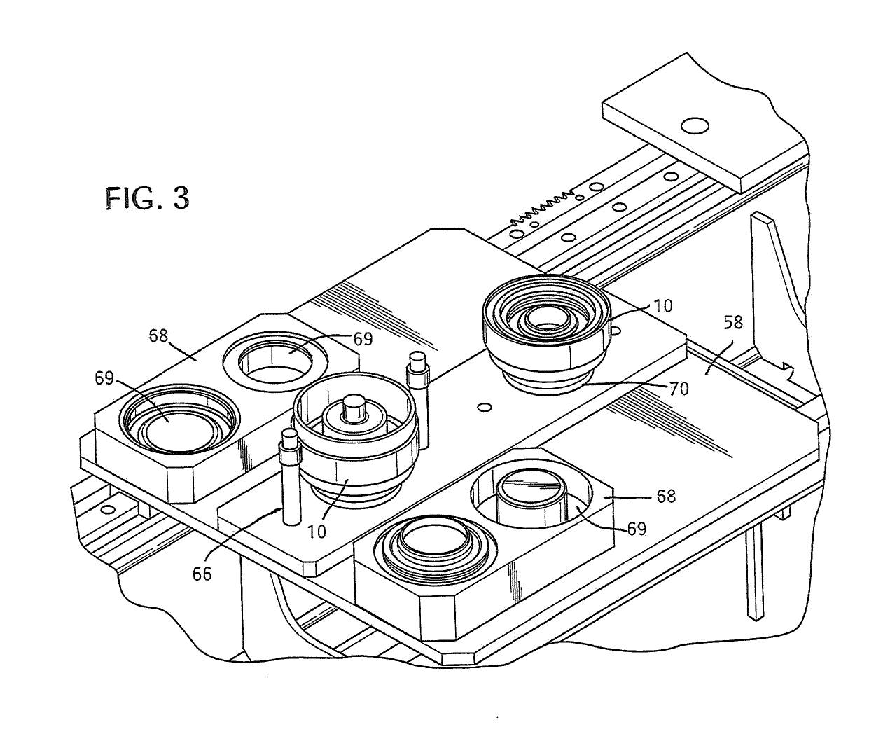

As shown in FIGS. 3-4 and 6, the assembly table 58 includes a clutch build fixture 66 and one or more kit trays 68 connected to the assembly table 58. The kit trays 68 have substantially cylindrical recesses 69 for receiving and holding the components of the clutch 10. The assembly table 58 further includes a staging fixture 70 connected thereto in which the clutch 10 may be held once the clutch 10 is fully assembled. A pair of substantially cylindrical posts 72 may be provided with the clutch build fixture 66 on the assembly table 58. The posts 72 are disposed adjacent a stepped cylinder 73 on the clutch build fixture 66 for supporting a seal assembly sleeve 74 with respect to the clutch 10 during the process of assembly thereof. The stepped cylinder 73 receives and holds the clutch housing 12 by having a spline 75 that engages the splined gear teeth 23 on the central bore 22 of the clutch housing 12.

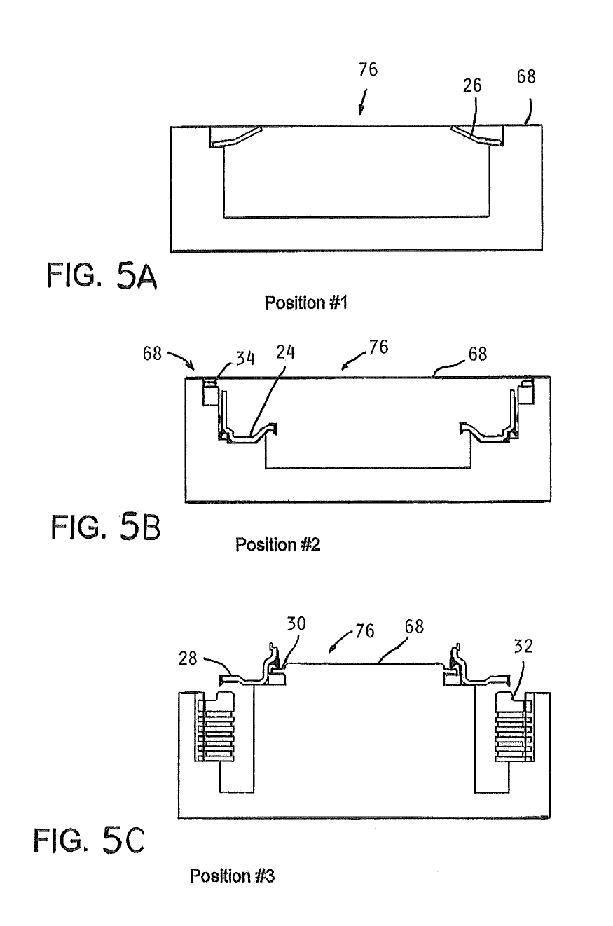

As shown in FIG. 5A, each of the kit trays 68 provided on the assembly table 58 defines one or more kit positions 76 in which components of the clutch 10 are stored prior to assembly. This allows the components of the clutch 10 to be placed in the kit trays 68 prior to assembly, such that the robotic arms 42 may pick up the components from the kit trays 68 as needed during the process of assembling the clutch 10. As an example, the disc spring 26 may be disposed on one of the kit trays 68 in a first kit position 76, as seen in FIG. 5A. As another example, the outer seal 24 and the outer snap ring 34 may be disposed in one of the kit trays 68 in a second kit position, as shown in FIG. 5B. As a further example, the inner seal 28, the inner snap ring 30, and the clutch pack 32 may be disposed in one of the kit trays 68 in a third kit position 76, as shown in FIG. 5C.

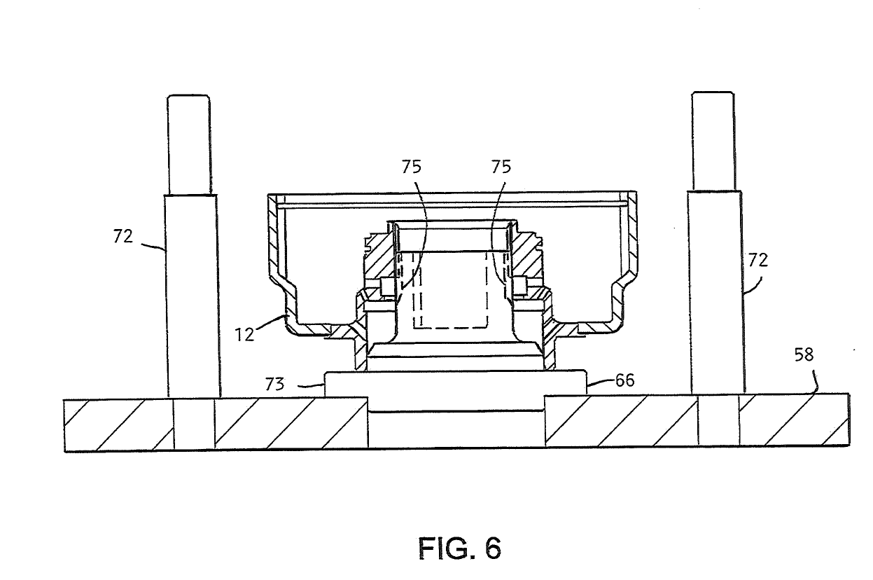

As shown in FIG. 6, assembly of the clutch 10 begins with placement of the clutch housing 12 on the clutch build fixture 66 by one of the robotic arms 42. The clutch housing 12 engages the stepped cylinder 73 of the clutch build fixture 66 to secure the clutch housing 12 to the clutch build fixture 66.

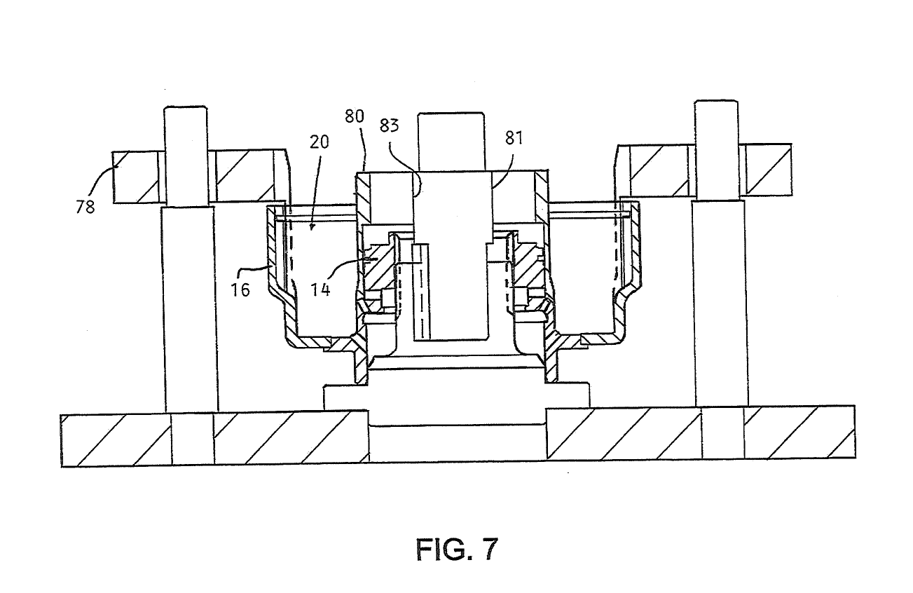

As seen in FIG. 7, an inner seal sleeve 78 is positioned on the posts 72 such that the inner seal sleeve 78 extends into the internal annular chamber 20 of the clutch housing 12. At the same time, an inner seal sleeve 80 is positioned on the stepped cylinder 73 of the clutch build fixture 66 by having a cylinder portion 81 of the sleeve 80 engage a substantially cylindrical recess 83 in the stepped cylinder 73 of the clutch build fixture 66, such that a portion of the inner seal sleeve 80 extends into the internal annular chamber 20 of the clutch housing 12 adjacent to the inner radial wall 14 thereof. The outer seal sleeve 78 and the inner seal sleeve 80 may be placed on the clutch build fixture 66 and within the clutch housing 12 simultaneously, by utilizing the manipulator 48 of one of the robotic arms 42. Both the outer seal sleeve 78 and the inner seal sleeve 80 serve to guide various components of the clutch 10 into their proper assembled locations during the subsequent assembly operations, as will be explained herein.

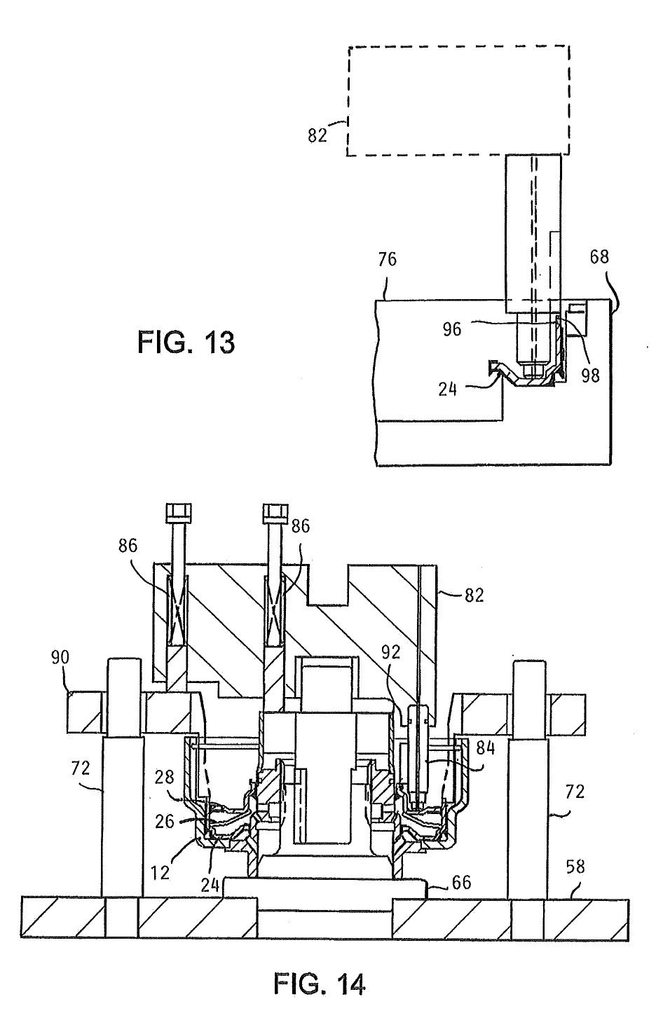

As shown in FIG. 13, components of the clutch 10 may be removed from the kit trays 68 such that the component is oriented in a particular fashion with respect to a tool, such as a vacuum gripper 84 of a piston loading tool 82. By way of example, the vacuum gripper 84 may include a spring-loaded key 96 that allows the piston loading tool 82 to sense a tab 98 that is formed in the outer seal 24. The piston loading tool 82 rotates until the spring-loaded key 96 registers with respect to the tab 98. Thus, the outer seal 24 is orientated in a predetermined position for assembling the outer seal 24 into the clutch housing 12.

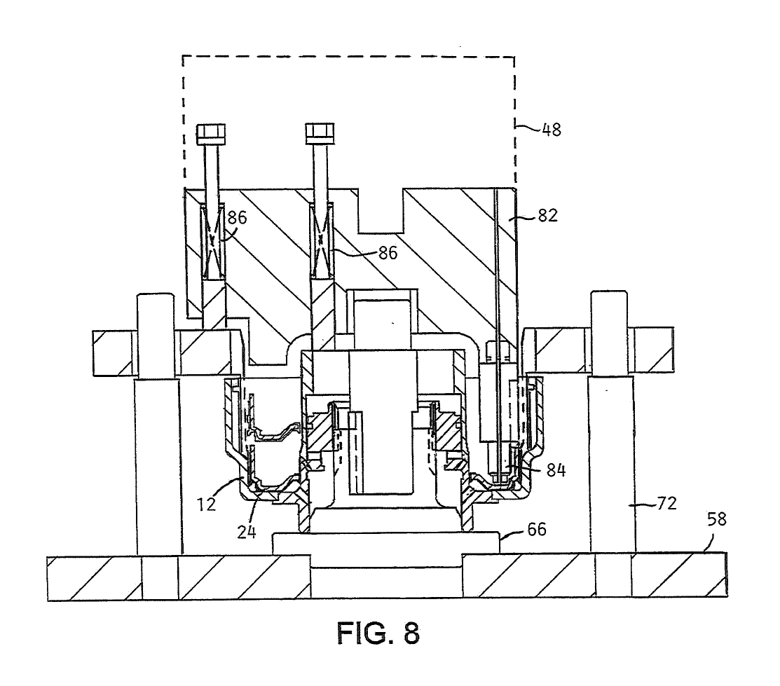

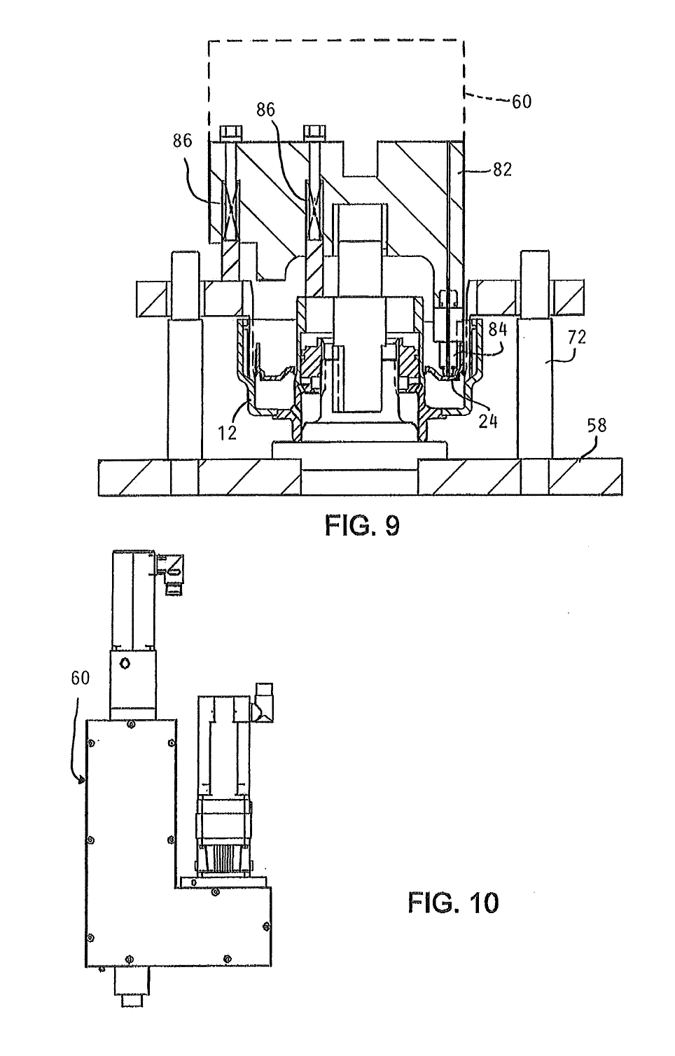

As shown in FIG. 8, the outer seal 24 is assembled with respect to the clutch housing 12 using the piston loading tool 82 that is connected to the manipulator 48 of one of the robotic arms 42. The piston loading tool 82 includes the vacuum gripper 84, which picks up the outer seal 24 from the kit tray 68 and places the outer seal 24 within the clutch housing 12, as guided by the outer seal sleeve 78 and the inner seal sleeve 80. Optionally, the piston loading tool 82 may be part of the press-and-rotate tool 60; in which case, the vacuum gripper 84 is rotated while pressing down upon the outer seal 24, and the vacuum gripper 84 is located in engagement with a tab that is formed on the outer seal 24 in order to enable rotation. In either case, spring plungers 86 may be utilized to maintain engagement of the outer seal sleeve 78 and the inner seal sleeve 80 with respect to the clutch housing 12 during assembly of the outer seal 24 with respect to the clutch housing 12. Use of the press-and-rotate tool 60 is reflected in FIG. 9 and shown in FIG. 10.

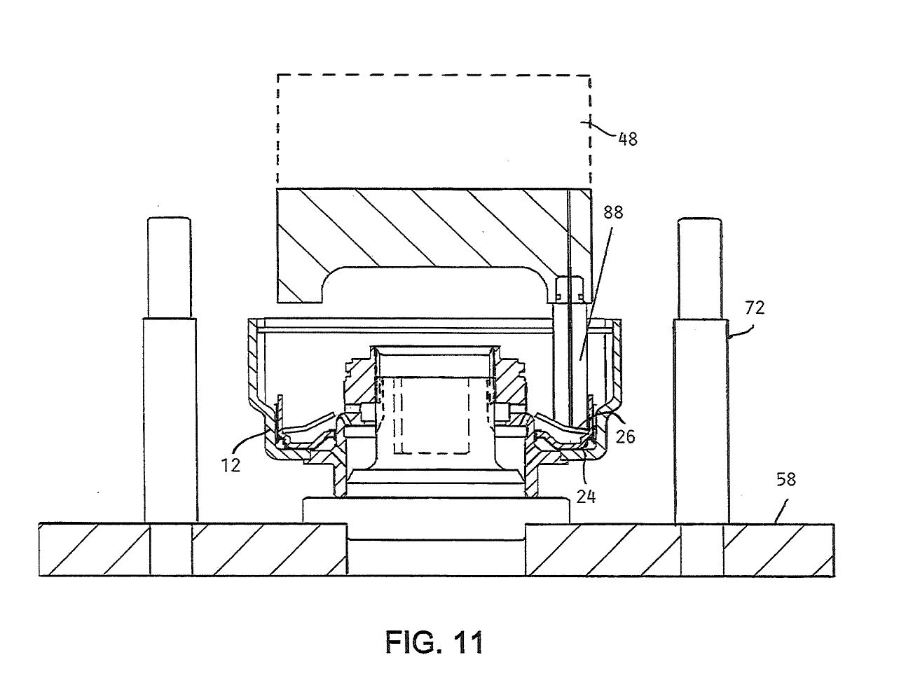

As shown in FIG. 11, the disc spring 26 is assembled onto the outer seal 24 using a vacuum tool 88. However, prior to installation of the disc spring 26, the outer seal sleeve 78 and the inner seal sleeve 80 are removed from the clutch housing 12 and the clutch build fixture 66.

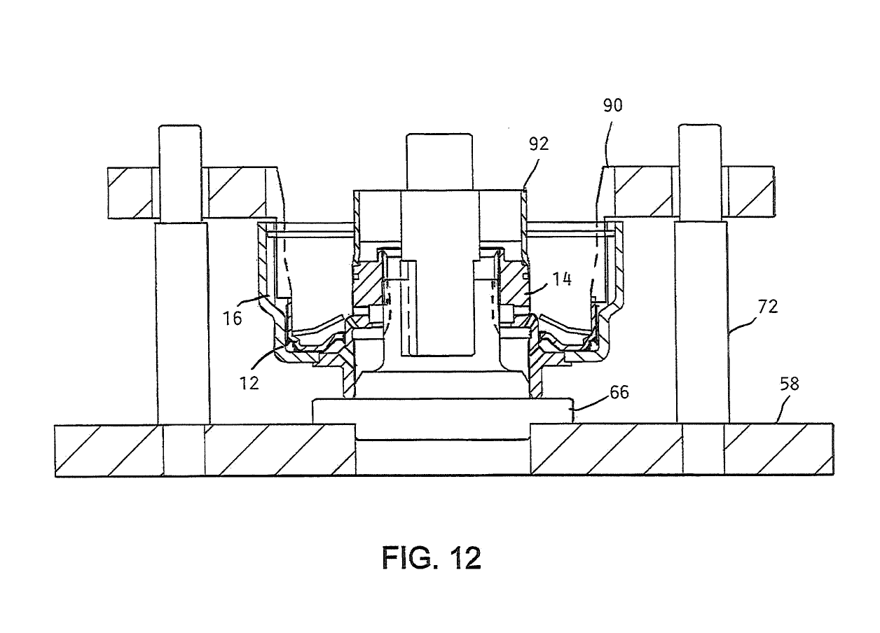

As shown in FIG. 12, an outer piston sleeve 90 and an inner piston sleeve 92 are disposed on the posts 72 and the stepped cylinder 73 of the clutch build fixture 66 by the manipulator 48 subsequent to installation of the disc spring 26, and both the outer piston sleeve 90 and the inner piston sleeve 92 extend at least partially into the clutch housing 12 to guide installation of the inner seal 28 with respect to the clutch housing 12.

The piston loading tool 82 is also utilized to assemble the inner seal 28 with respect to the clutch housing 12 including registration of the vacuum gripper 84 of the piston loading tool 82 with respect to a tab (not shown) in the inner seal 28 with a spring-loaded key 96 of the piston loading tool 82, as shown in FIG. 14. The vacuum gripper 84 rotates while pressing down the inner seal 28. Once again, the spring plungers 86 may be utilized to maintain engagement of the outer seal sleeve 78 and the inner seal sleeve 80 with respect to the clutch housing 12 during assembly of the inner seal 28 to the clutch housing 12.

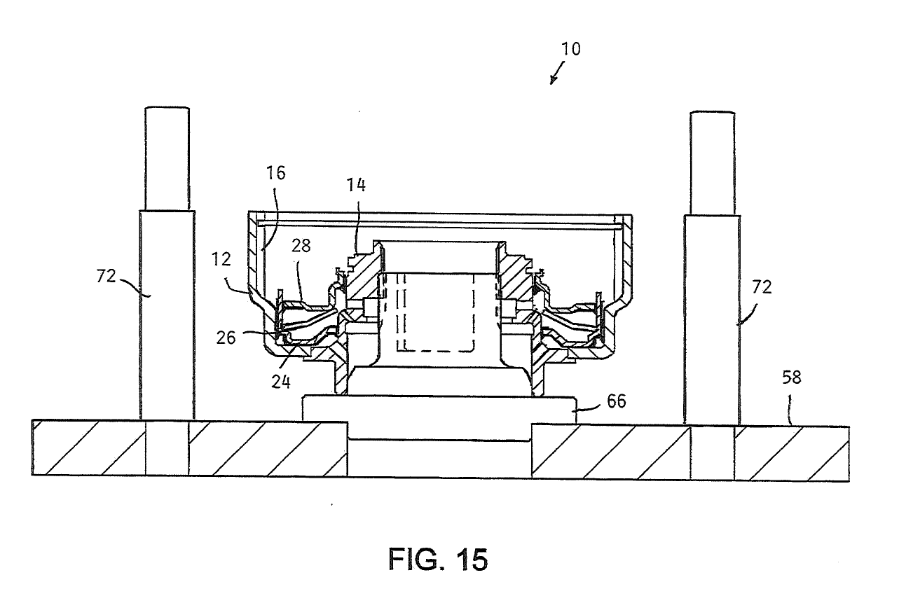

FIG. 15 shows the clutch 10 subsequent to the assembly of the outer seal 24, the disc spring 26, and the inner seal 28 with respect to the clutch housing 12, wherein the outer piston sleeve 90 and the inner piston sleeve 92 were removed from the clutch build fixture 66 and the clutch housing 12.

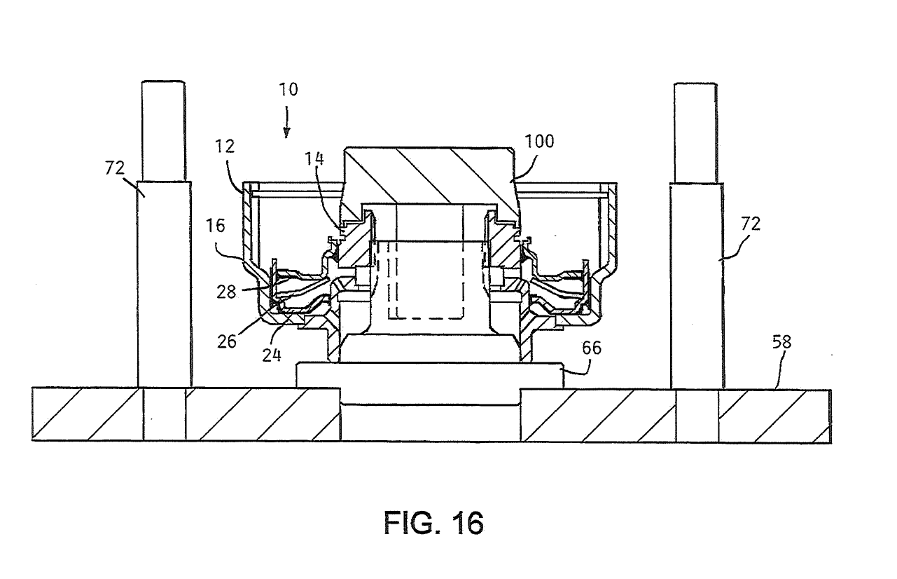

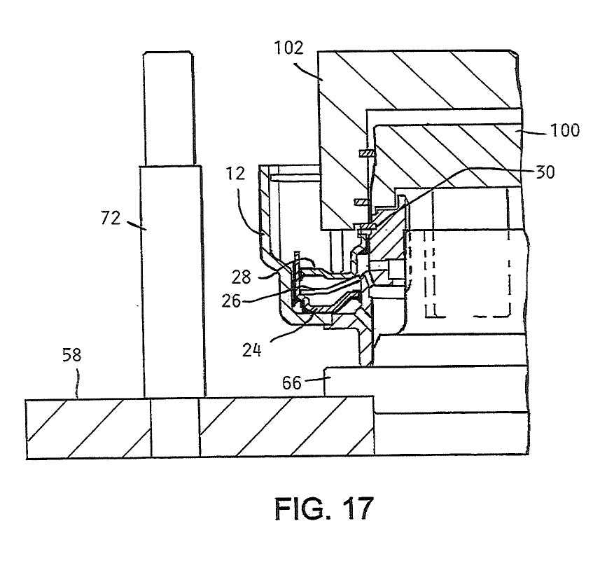

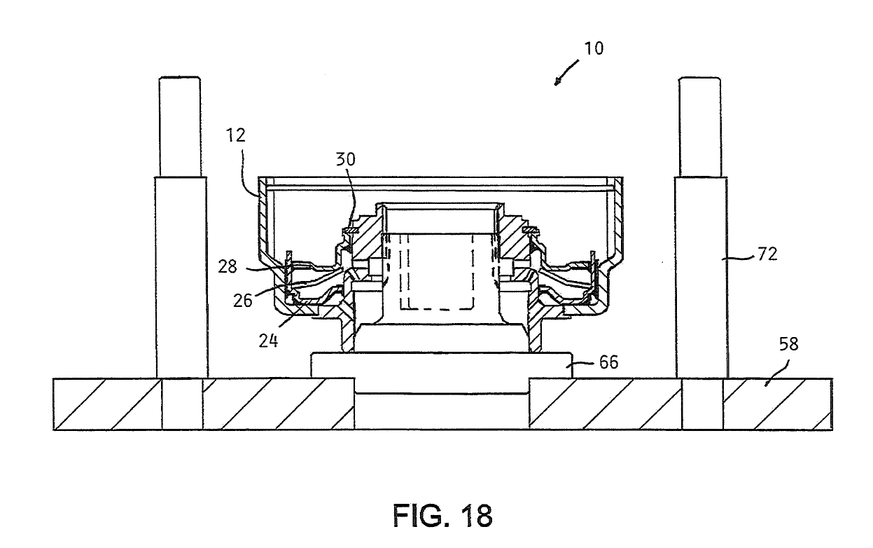

As seen in FIG. 16, a snap ring cone 100 may be placed on the stepped cylinder 73 of the clutch build fixture 66 by one of the robotic aims 42 to aid installation of the inner snap ring 30. The inner snap ring 30 is first loaded onto the snap ring cone 100 using a gripper (not shown) prior to being forced downward with respect to the snap ring cone 100. The geometry of the snap ring cone 100 is such that the inner snap ring 30 is expanded as the snap ring 30 is slid downward over the snap ring cone 100, and thus, the diameter of the snap ring cone 100 is similar to that of the diameter of the inner radial wall 14 adjacent to the internal annular channel 20 of the clutch housing 12 where the snap ring cone 100 meets the clutch housing 12. As shown in FIG. 17, the inner snap ring 30 is moved downward using a snap ring press 102 until the inner snap ring 30 is moved off of the snap ring cone 100 and seats with respect to the clutch housing 12 to maintain the inner seal 28 in its proper position with respect to the clutch housing 12. The clutch 10 is shown in FIG. 18 subsequent to installation of the inner snap ring 30 after the removal of the snap ring cone 100.

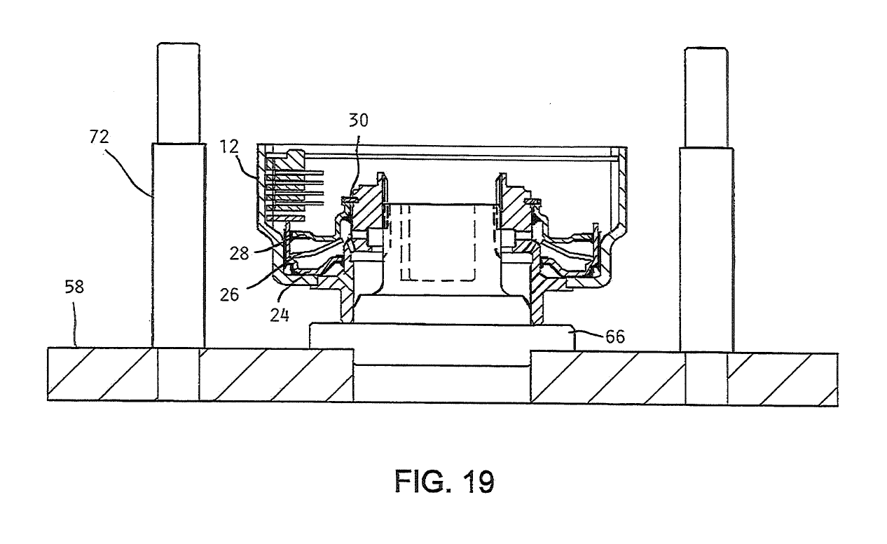

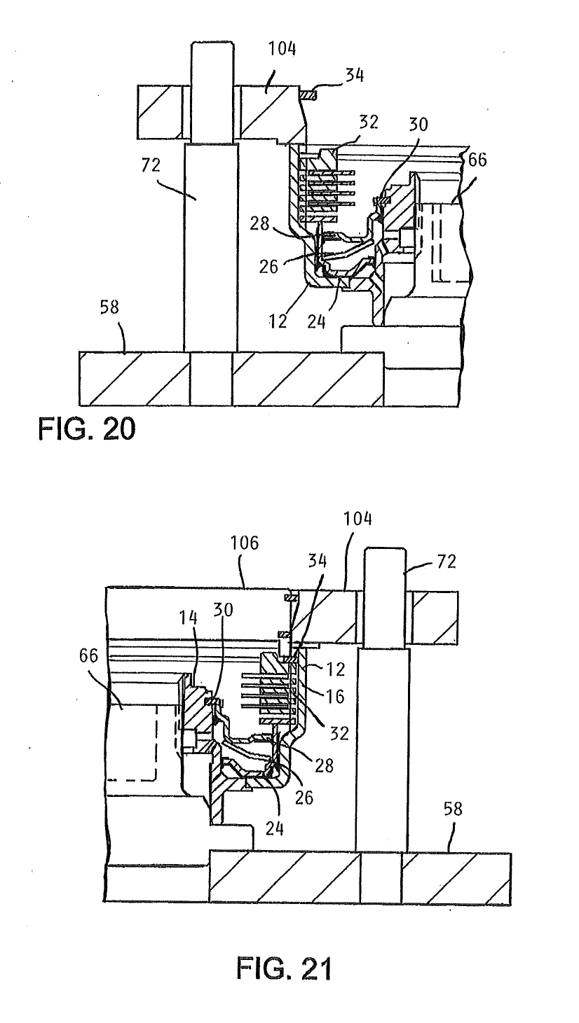

As shown in FIG. 19, the clutch pack 32 is loaded into the clutch housing 12 using one of the robotic arms 42. Subsequent to installation of the clutch pack 32, a snap ring sleeve 104 is loaded onto the posts 72 of the clutch build fixture 66, as shown in FIG. 20. A gripper (not shown) that is associated with one of the robotic arms 42 loads the outer snap ring 34 into the snap ring sleeve 104. A second snap ring press 106 then engages the outer snap ring 34 and forces the outer snap ring 34 downward with respect to the snap ring sleeve 104, thereby constricting the outer snap ring 34. Once the outer snap ring 34 has been pressed inward and downward past the snap ring sleeve 104 by the second snap ring press 106, the outer snap ring 34 is disposed within the clutch housing 12 and may be pushed into engagement with a notch 107 that is formed in the clutch housing 12, such that the outer snap ring 34 retains the clutch pack 32 within the clutch housing 12. The snap ring sleeve 104 and the second snap ring press 106 are removed from the clutch build fixture 66 and the clutch housing 12.

Subsequent to installation of the outer snap ring 34, the clutch 10 is in a fully assembled condition and may be placed onto one of the testing fixtures 54 of the test station 52 by one of the robotic arms 42 for a leak test and gauging operation. While the leak test is being performed on the completed clutch 10, another clutch 10 may be assembled at the assembly station 56.

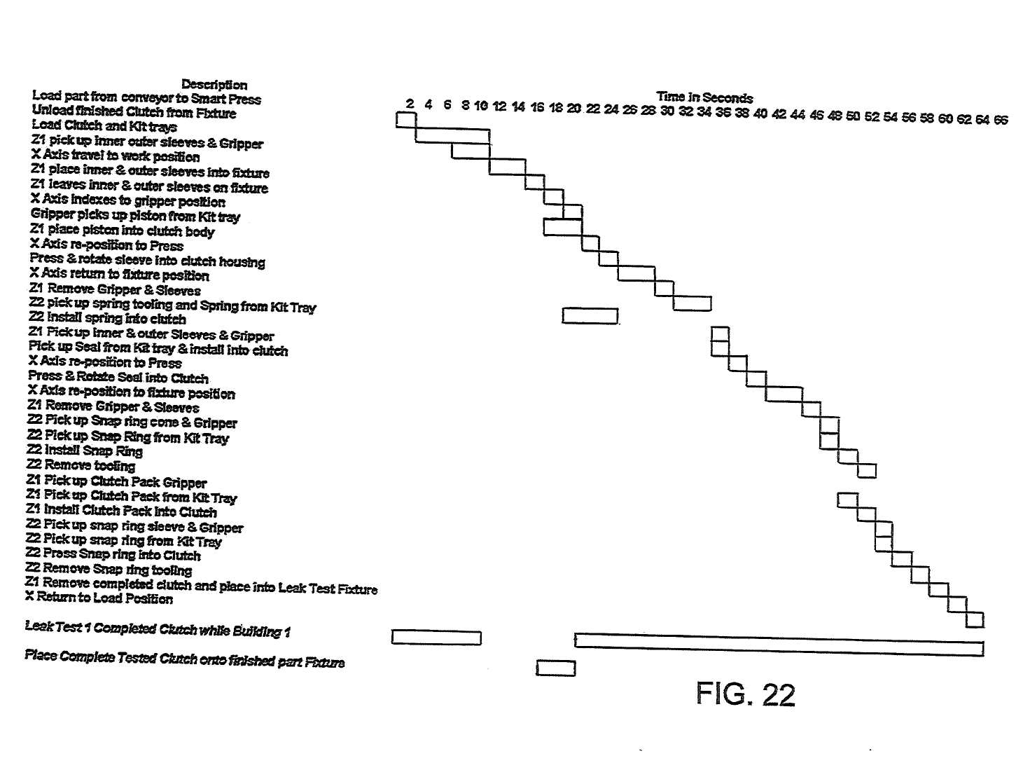

FIG. 22 shows the order in which the steps of the process described herein are performed. It should be noted that several of the operations described herein may be performed in parallel with one another, thus resulting in a time savings.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An apparatus for automatically assembling a clutch, comprising:
an assembly station having an assembly table;
a clutch fixture connected to said assembly table and adaptable to receive a clutch housing;
at least one tray connected to said assembly table and adaptable to receive clutch components of said clutch;
at least one robotic arm engageable with said clutch housing and said clutch components for loading and unloading said clutch housing onto and from said clutch fixture and said clutch components into and from said at least one tray;
a manipulator connected to and in communication with said at least one robotic arm for automatically engaging an appropriate tool for assembling said clutch components into said clutch housing; and
at least one assembly fixture removably connected to said clutch fixture and connectable to said clutch housing for assisting in the assembly of said clutch components to said clutch housing.

2. The apparatus as stated in claim 1, wherein said assembly fixture further comprises:
an outer and inner seal sleeve removably connected to said clutch fixture and engageable with said clutch housing for assisting in the assembly of said clutch components to said clutch housing.

3. The apparatus as stated in claim 1, wherein said assembly fixture further comprises:
a snap ring mounting device releasably connected to said clutch fixture and engageable with said clutch housing for assisting in the assembly of said clutch components to said clutch housing.

4. The apparatus as stated in claim 1, wherein said assembly fixture further comprises:
a plate having a stepped cylindrical structure connected thereto and engageable with said clutch housing.

5. The apparatus as stated in claim 4, further comprising:
a pair of substantially cylindrical posts connected to said plate adjacent said stepped cylindrical structure for receiving said at least one assembly fixture.

6. The apparatus as stated in claim 1, wherein said tool further comprises:
a vacuum gripper releasably engageable with said clutch components for moving and assembling said clutch components into said clutch housing.

7. The apparatus as stated in claim 1, wherein said tool further comprises:
a rotatable press engageable with said clutch components for assembling said clutch components to said clutch housing.

8. The apparatus as stated in claim 1, wherein said tool further comprises:
at least one spring-loaded plunger engageable with said clutch components for maintaining said clutch components in a predetermined position while assembling said clutch components to said clutch housing.

9. The apparatus as stated in claim 1, wherein said tool further comprises:
a snap ring press engageable with said clutch components for assembling said clutch components to said clutch housing.

10. The apparatus as stated in claim 1, further comprising:
a test station engageable with an assembled clutch housing for testing the structural and functional integrity of said assembled clutch housing.

11. A method for assembling a clutch, the steps comprising:
providing an assembly station having an assembly table, a clutch fixture connected to said assembly table, at least one tray connected to said assembly table, and at least one robotic arm;
placing a clutch housing on said clutch fixture and said clutch components in at least one tray with said at least one robotic arm;
engaging an appropriate tool with a manipulator connected to and in communication with said at least one robotic arm for assembling said clutch components to said clutch housing; and
removably connecting at least one assembly fixture to said clutch fixture and said clutch housing to assist in the assembly of said clutch components to said clutch housing.

12. The method as stated in claim 11, further comprising the steps of:
providing an outer and inner seal sleeve as said at least one assembly fixture.

13. The method as stated in claim 11, further comprising the steps of:
providing a snap ring mounting device as said at least one assembly fixture.

14. The method as stated in claim 1, further comprising the steps of:
providing a plate as said clutch fixture having a stepped cylindrical structure connected thereto for receiving and securing said clutch housing.

15. The method as stated in claim 14, further comprising:
providing a pair of substantially cylindrical posts connected to said plate adjacent said stepped cylindrical structure for receiving said at least one assembly fixture.

16. The method as stated in claim 1, further comprising the steps of:
providing a vacuum gripper as the tool for releasably engaging said clutch components and moving said clutch components into said clutch housing.

17. The method as stated in claim 11, further comprising the steps of:
providing a rotatable press as said tool for engaging said clutch components and applying pressure to said clutch components in said clutch housing.

18. The method as stated in claim 11, further comprising the steps of:
providing at least one spring-loaded plunger as the tool for engaging and maintaining said clutch components in a predetermined position in said clutch housing.

19. The method as stated in claim 1, further comprising the steps of:
providing a snap ring press as said tool for engaging said clutch components and assembling said clutch components to said clutch housing.

20. The method as stated in claim 11, further comprising the steps of:
providing a test station engageable with an assembled clutch housing for testing the structural and functional integrity of the assembled clutch housing.
